(19) United States
(12) Patent Application Publication
(10) Pub. No.: US 2024/0354556 A1
(43) Pub. Date: Oct. 24, 2024

(54) GENERATING SESSION-BASED RECOMMENDATIONS USING LARGE LANGUAGE MACHINE-LEARNED MODELS

(71) Applicant: Maplebear Inc., San Francisco, CA (US)

(72) Inventors: Yueyang Rao, Albany, CA (US); Brian Lin, La Canada Flintridge, CA (US); Angadh Singh, Dublin, CA (US); Sharath Rao Karikurve, Berkeley, CA (US); Guanghua Shu, Sunnyvale, CA (US)

(21) Appl. No.: 18/640,231

(22) Filed: Apr. 19, 2024

Related U.S. Application Data
(60) Provisional application No. 63/460,439, filed on Apr. 19, 2023.

(51) Int. Cl. G06N 3/0455; G06Q 30/0601

(52) U.S. Cl. CPC G06N 3/0455; G06Q 30/0631

(57) ABSTRACT

An online system generates session-based recommendations for a user accessing an application of the online system. The online system receives, from one or more client devices, a sequence of actions performed by a user during a session of an application of an online system. The online system generates a sequence of tokens from the sequence of actions by tokenizing an action to a token representing a respective item identifier. The online system applies a transformer-based machine-learned model to the sequence of tokens to generate predictions for a set of items. The online system selects a subset of items based on the generated predictions for the set of items. The online system generates one or more recommendations to the user from the selected subset of items and displays the recommendations to the user.

### CROSS-REFERENCE TO RELATED APPLICATIONS

This application claims the benefit of U.S. Provisional Patent Application No. 63/460,439, filed on Apr. 19, 2023, which is incorporated herein by reference in its entirety.

### BACKGROUND

An online system is an online platform that deploys applications to users. A user can access an instance of the application to perform various actions during a session. As an example, the online system may allow a user to purchase items from participating retailers. After logging into the application, a user may perform various user actions, such as adding an item to the cart, viewing a particular product, or browsing history that can provide significant context into the user's intent. However, it may be difficult for online systems to leverage the context generated during a user's browsing session.

### SUMMARY

In accordance with one or more embodiments, an online system generates session-based recommendations for a user accessing an application of the online system. In particular, the online system receives, from one or more client devices, a sequence of actions performed by a user during a session of an application of an online system. The online system generates a sequence of tokens from the sequence of actions by tokenizing an action to a token representing a respective item identifier. The online system applies a transformer-based machine-learned model to the sequence of tokens to generate predictions for a set of items. A prediction for a respective item may indicate a likelihood the user will interact with a content item related to the item as a next action. The online system selects a subset of items based on the generated predictions for the set of items. The selected subset of items may have predictions above a predetermined threshold. The online system generates one or more recommendations to the user from the selected subset of items and displays the recommendations to the user.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3A illustrates an example pre-training process of a generator model and a discriminator model, in accordance with one or more embodiments.

FIG. 3B illustrates an example training process of a classification layer, in accordance with one or more embodiments.

FIG. 4 illustrates an example inference process using the generator and the classification layer, in accordance with one or more embodiments.

FIG. 5 is a flowchart for a method of generating recommendations using a transformer-based recommendation model, in accordance with some embodiments.

### DETAILED DESCRIPTION

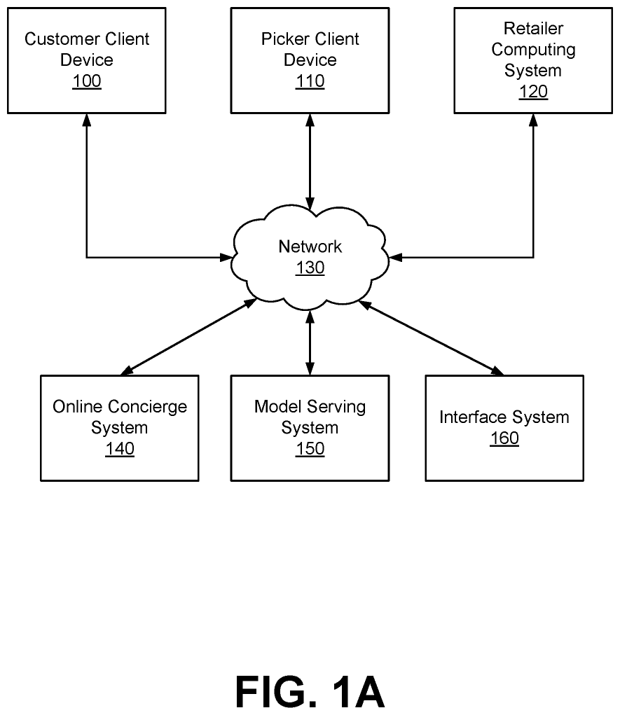

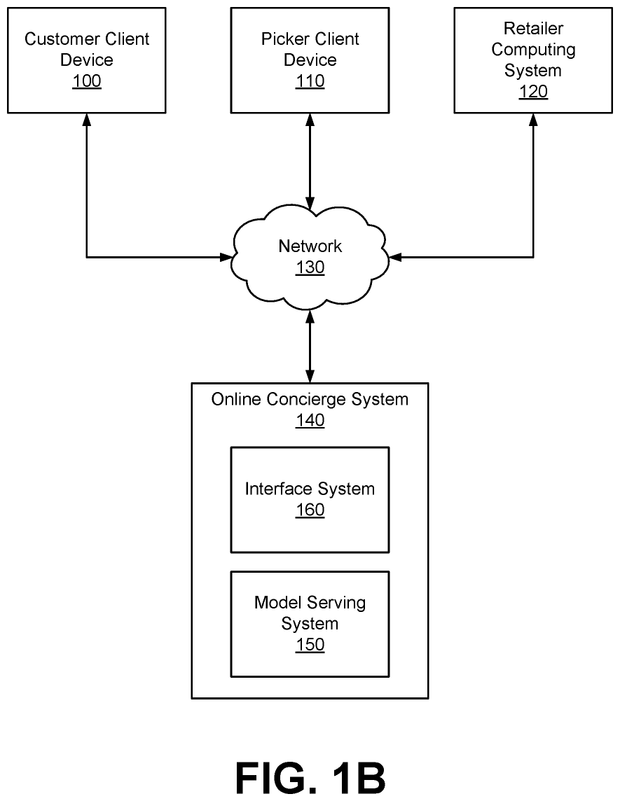

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

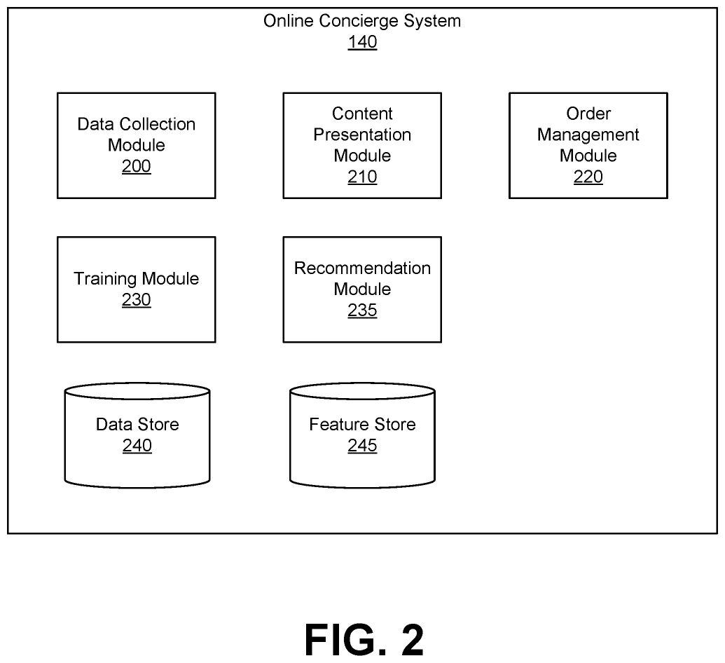

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

Thus, in one or more embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

In one or more embodiments, the online system 140 trains a machine-learned recommendation model coupled to receive a sequence of actions during a browsing session of the user and generate a prediction on the user's next action. For example, a browsing session may be a session when the user logs on to the application and logs off the application. In one instance, a user action includes addition of an item to the user's order, viewing of an item, deletion of an item from the user's order, search queries to the online system 140, and the like. Thus, given a sequence of user actions (e.g., add apples to cart>add flour to cart>view cinnamon>search oatmeal), the recommendation model generates a prediction for the user's next action, for example, which item the user is likely to add in the user's order next. For example, the prediction may indicate that the user is likely to add nutmeg to the order. In this manner, the recommendation model can infer context from a user's browsing session, such as the user's searches, cart adds, and product views. This context not only reveals the user's intent, but also the user's dietary, brand, and price preferences as well based on the ordering of actions the user performed during the browsing session.

In one or more embodiments, the recommendation model is also configured as a transformer-based architecture including a set of encoders and/or a set of decoders that each are coupled to receive a set of inputs and generate a set of outputs. An encoder and/or a decoder of a transformer-based architecture may include an attention operation that generates keys, queries, and values from the inputs to generate attention outputs. In one instance, the recommendation model is configured as a transformer architecture with both encoder and decoders. In other embodiments, the transformer architecture includes only encoders or only decoders. However, it is appreciated that in other embodiments, the recommendation model can be configured as any other appropriate architecture including, but not limited to, LSTM networks, Markov networks, BERT, GPT, and the like.

In one or more embodiments, the online system 140 performs a tokenization process where the online system 140 constructs a token space or in other words, a vocabulary space, that defines a subset of items that will be represented by the recommendation model. Specifically, the online system 140 selects a subset of items from, for example, an item catalog managed by the online system 140, and represents each selected item as a unique token in the token space. For example, the subset of items may each be associated with a product identifier (ID) (e.g., ID 2685659) and the product ID is mapped to an integer-valued token identifier (ID) (e.g., ID 12345).

During the inference process after the recommendation model has been trained, the online system 140 manages a feature store that stores various user actions of a user for a current (or previous) browsing session. For example, the feature store may include a history of user actions such as addition of items to the user's order, viewing of particular items, search queries the user submitted, and the like. The online system 140 receives information on a user identifier that has initiated a browsing session. As the feature store stores the user actions, the online system 140 retrieves the features specific to the particular user. The online system 140 applies the recommendation model to the retrieved features to generate a prediction (e.g., of the user's next likely action). In one instance, the online system 140 obtains one or more predicted items with the highest prediction likelihoods.

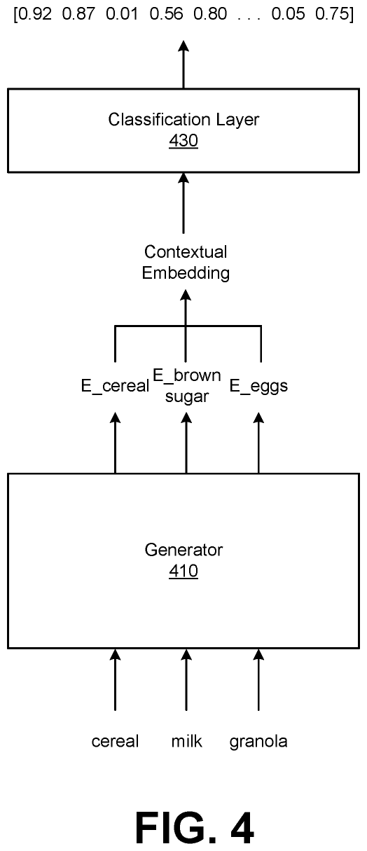

The online system 140 may use the selected subset of items for various use cases, as further described in more detail in conjunction with FIG. 4. In one instance, the selected subset of items are used to generate organic recommendations to the user, for example, as a list of recommended items to add to the user's order. In another instance, the selected subset of items may be sponsored by an advertiser, a retailer, and the like, and the selected subset of items may be provided to an advertising module that submits the selected subset of items to a bidding process where advertisements or campaigns associated with the selected subset of items are identified and a bidding process is performed to select an advertisement for display to the user of the browsing session, such that the user is likely to convert on the advertisement.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, an automated action module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In one or more embodiments, the data collection module 200 also collects communication data, which is different types of communication between shoppers and users of the online system 140. For example, the data collection module 200 may obtain text-based, audio-call, video-call based communications between different shoppers and users of the online system 140 as orders are submitted and fulfilled. The data collection module 200 may store the communication information by individual user, individual shopper, per geographical region, per subset of users having similar attributes, and the like.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In one or more embodiments, the content presentation module 210 receives one or more recommendations for presentation to the customer while the customer is engaged with the ordering interface. The list of ordered items of a customer may be referred to as a basket. As described in conjunction with FIGS. 1A and 1B, the recommendations are generated based on the inferred purpose of the basket of the customer and include one or more suggestions to the customer to better fulfill the purpose of the basket.

In one instance, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 210 may present the equivalent basket to the customer via the ordering interface with an indicator that states how an equivalent basket improves or is different from the existing basket (e.g., more cost-effective, healthier, sponsored by a certain organization). The content presentation module 210 may allow the customer to swap the existing basket with an equivalent basket.

In one instance, when the basket includes a list of edible ingredients, the recommendations are in the form of a list of potential recipes the ingredients can fulfill, and a list of additional ingredients to fulfill each recipe. The content presentation module 210 may present each suggested recipe and the list of additional ingredients for fulfilling the recipe to the customer. The content presentation module 210 may allow the customer to automatically place one or more additional ingredients in the basket of the customer.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The training module 230 trains machine learning models used by the online system 140. For example, the training module 230 may train the item selection model, the availability model, any of the machine-learned models deployed by the model serving system 150, and the recommendation model described in conjunction with FIG. 1. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The training module 230 generates the set of parameters for a machine learning model by “training” the machine learning model. Once trained, the machine learning model uses the set of parameters to transform inputs into outputs.

The training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The training module 230 may apply an iterative process to train a machine learning model whereby the training module 230 trains the machine learning model on each of the set of training examples. To train a machine learning model based on a training example, the training module 230 applies the machine learning model to the input data in the training example to generate an output. The training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The training module 230 updates the set of parameters for the machine learning model based on the score generated by the loss function. For example, the training module 230 may apply gradient descent to update the set of parameters.

In one or more embodiments, the training module 230 trains the recommendation model configured to leverage context of a user's browsing history to make one or more recommendations. As described in conjunction with FIG. 1, the training module 230 may construct a token space for a recommendation model that represents the space of items represented in the recommendation model. In one instance, the number of items represented in the token space is significantly smaller than the total number of available items in a product catalog of the online system 140. For example, the number of items represented in the token space may be equal to or below 20%, 15%, 10%, and so on, of the total number (e.g., 15 million items) of items. This is because the size of the token space directly impacts the recommendation model's memory footprint and inference time.

In one or more embodiments, the training module 230 performs a tokenization process to select the subset of items in the token space. In one or more embodiments, the training module 230 tokenizes the set of items in the catalog that are associated with sponsorship (e.g., associated with ads, sponsored activity). For each retailer associated with the online system 140, the training module 230 ranks the items of the retailer with respect to a performance metric, such as conversion, of the item. The training module 230 tokenizes a first subset of items (e.g., N) for the retailer that has a highest performance metric (e.g., highest conversions). The training module 230 tokenizes a second subset of items (e.g., M) across all retailers associated with the online system 140. The training module 230 also dedupes replicates between the subsets of tokenized items, and selects N (for each retailer) and M such that top P % of the total conversions are covered by the subset of items. For example, N may be 5,000, M may be 100,000, and P may be 95%. In one or more embodiments, a token representing an item is encoded as a one-hot vector where the element for the known item is a one and the remaining elements are zero.

By performing tokenization with items that have sponsorship (e.g., associated with advertisements), the output of the recommendation model deployed during inference time can be used to generate both organic recommendations (e.g., display list of recommended items for addition to user's order given context so far during current browsing session) and/or sponsored recommendations (e.g., display ads to user).

The training module 230 obtains training data for training parameters of the recommendation model. In one or more embodiments, the training data includes one or more training instances. In one instance, a training instance includes already known sequences of user actions that were previously completed as orders. Therefore, a training instance may be in the form of a user ID and a sequence of user actions represented as a sequence of token ID's (corresponding to product IDs). For example, a training instance may be [user ID], [2433]>[9844]>[34839]>[8544], where the sequence indicates this particular user added item with token ID 2433 (e.g., corresponding to eggs), then viewed item with token ID 9874 (e.g., corresponding to cake batter), then added item with token ID 34839 (e.g., corresponding to vanilla extract), and then a query for the item with token ID 8544 (e.g., corresponding to cake sprinkles) was submitted. In one example, the training module 230 may collect session-based sequence data on a daily basis, weekly basis, monthly basis, and the like.

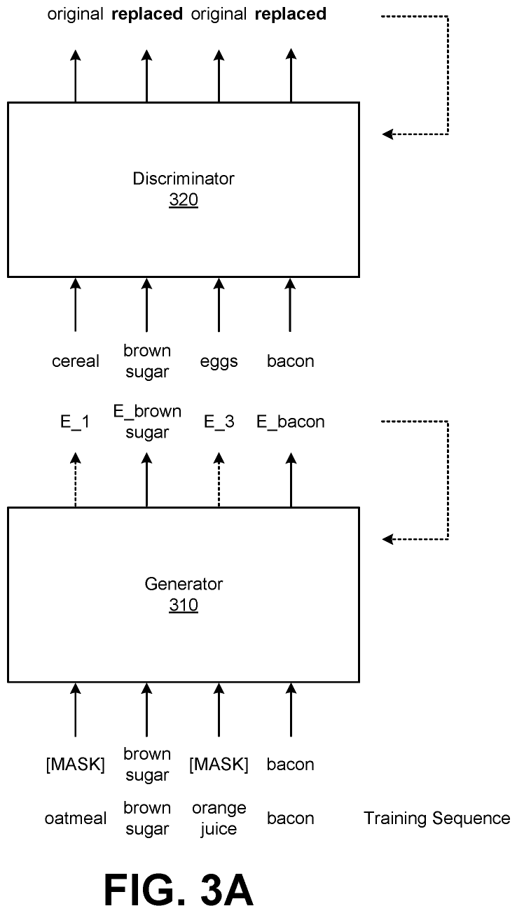

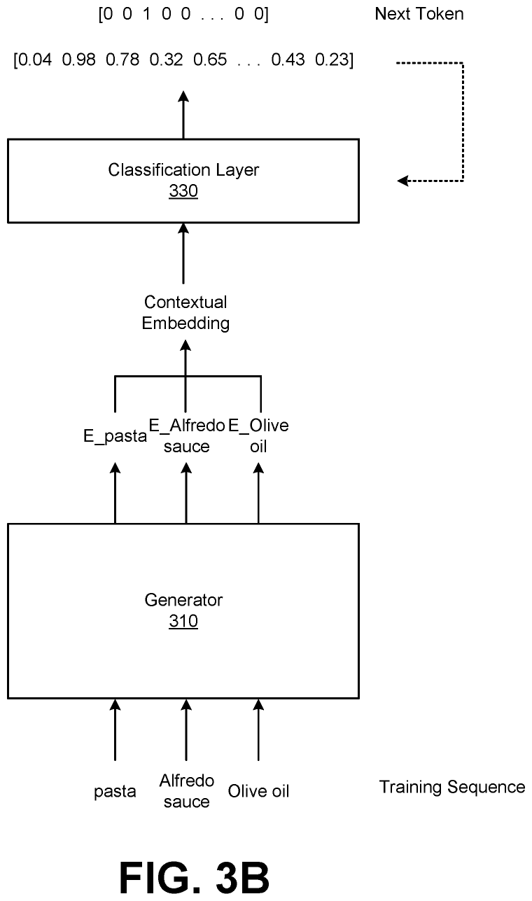

In one or more embodiments, the recommendation model is configured as a machine-learned generator model and a classification layer. The generator model is coupled to receive a sequence of input tokens and generate an embedding for each position. An embedding may be defined herein as a multi-dimensional tensor (e.g., 1×h) where one dimension corresponds to the length of the sequence (number of tokens) and a second dimension corresponds to the number of elements in a hidden state of the embedding. A trained generator model learns relationships between different words (or other text units) in the input sequence and the embeddings generated for the tokens incorporate these relationships when trained. In one or more embodiments, the generator model is trained in conjunction with a discriminator model, as described in conjunction with FIG. 3A. The classification layer is coupled to receive a contextual embedding (e.g., combination of embeddings generated for an input sequence) and generate a set of predictions for the set of items, where each prediction indicates a likelihood the user will interact with a content item or recommendation associated with the respective item given the sequence of actions encoded for the user.

In one or more embodiments, the training module 230 trains the recommendation model by performing a pre-training process to learn the embedding space for the vocabulary of items. During the pre-training process, the parameters of the generation model and the discriminator model are updated. The training module 230 then performs a training process to train parameters of the classification layer, such that the classification layer can predict items that a user will likely interact with given a sequence of items associated with a sequence of user actions.

### Pre-Training Process for Learning Embedding Space

FIG. 3A illustrates an example pre-training process of a generator model and a discriminator model, in accordance with one or more embodiments. As shown in the example of FIG. 3A, in one or more embodiments, a generator model 310 is trained in conjunction with a discriminator model 320. In one instance, the generator model 310 and the discriminator model 320 are each configured as transformer architectures. The training module 230 obtains training data including a set of training sequences to train the parameters of the generator model 310 and the discriminator model 320. As described above, a training sequence encodes a sequence of actions for a user into a sequence of tokens.

During the pre-training process, the training module 230 masks a subset of tokens in the training sequences. As illustrated in FIG. 3A, an example training sequence may be four tokens [oatmeal]>[brown sugar]>[orange juice]>[bacon] (in actuality represented by corresponding item ID's for particular brands, e.g., [84738]>[839]>[34339]>[7524]). The first and third tokens are masked and replaced by a [MASK] token (e.g., or any other special token) to generate a masked input token sequence. The generator model 310 is coupled to receive the masked input token sequence and generate an embedding for each position of the masked token. In the example of FIG. 3A, the embedding E_1 is generated for the first position (which was masked), embedding E_brown sugar is generated for the second position, embedding E_3 is generated for the third position (which was masked), and embedding E_bacon is generated for the fourth position.

The embeddings generated for the input token sequence can be mapped to output tokens that each correspond to a respective item in the vocabulary. For example, the training module 230 applies a softmax layer to an embedding and selects the element with the highest probability in the output corresponding to a respective item. In the example illustrated in FIG. 3A, embedding E_1 is mapped to a cereal item and embedding E_3 is mapped to an eggs item. This process is repeated for other training sequences in the training data.

The training module 230 then generates a “corrupt” sequence by replacing original tokens for one or more masked positions in the training sequence with the generated sample (i.e., output token) from the generator model 310. In the example shown in FIG. 3A, the training module 230 generates a corrupted sequence [cereal]>[brown sugar]>[eggs]>[bacon], where the first position and the third position are replaced by tokens sampled from the generator 310 output (e.g., from embeddings E_1 and E_3).

The discriminator model 320 is coupled to receive a corrupted sequence and generate a prediction for each position indicating whether the respective input token for the position is a replaced token or an original token. Therefore, the output from the discriminator model 320 for each position is a likelihood (e.g., a value between 0 and 1) that the respective input token is an original token or a replaced token. In one or more embodiments, a high (e.g., 1) likelihood indicates the input token is an original token, while a low (e.g., 0) likelihood indicates the input token is a replaced token. In the example shown in FIG. 3A, the discriminator model 320 estimates the first token is an original token, the second token is a replaced token, the third token is an original token, and the fourth token is a replaced token, each with some likelihood value.

For the training sequence, the training module 230 computes a loss function including a generator loss and a discriminator loss. In one or more embodiments, the generator loss is dependent on the likelihood of generating the correct (original) token in the vocabulary for a masked position. For example, the generator loss for the training sequence shown in FIG. 3A may be dependent on a likelihood the correct token for [oatmeal] is generated for the first position and a likelihood the correct token for [orange juice] is generated for the third position.

In one or more embodiments, if the input token is an original token, the discriminator loss is dependent on the likelihood generated by the discriminator model 320 that the input token is an original token and/or the likelihood the generator model 310 generates the original token. If the input token is a replaced token, the discriminator loss is dependent on the likelihood generated by the discriminator model 320 that the input token is a replaced token and/or the likelihood the generator model 310 generates the replaced token. The discriminator loss may be combined over the sequence of input tokens.

In one or more embodiments, the loss function is given by a sum of the generator loss and the discriminator loss. The training module 230 obtains one or more terms from the loss function, and backpropagates parameters of the discriminator 320 model and the generator model 310 to reduce the loss function. In this manner, the generator model 310 is incrementally trained to generate sequences that resemble plausible sequences resembling actual sequences, and the discriminator model 320 is incrementally trained to differentiate fake sequences from actual sequences. This process is repeated for sets of training sequences until a convergence criterion is reached.

### Training Process for Learning Classification Layer

FIG. 3B illustrates an example training process of a classification layer, in accordance with one or more embodiments. During the training phase, the training module 230 trains the parameters of a classification layer (i.e., neural network with one or more layers). In one or more embodiments, the classification layer is coupled to receive a contextual embedding representing a sequence of input tokens (e.g., obtained from a sequence of actions) and generate a set of predictions for the items in the vocabulary. A prediction indicates a likelihood the item is associated with the next action for the user and is indicative of a likelihood the user will interact with a content item associated with the item.

In one or more embodiments, the training module 230 identifies a sequence of input tokens in a training sequence and a next token that comes after (e.g., directly after) the sequence of input tokens. For example, a training sequence may be a sequence of user actions represented by [pasta]>[Alfredo sauce]>[Olive oil]>[chili pepper]. The training module 230 may identify a sequence of input tokens as [pasta]>[Alfredo sauce]>[Olive oil] and the next token as [chili pepper]. Moreover, the training module 230 may obtain multiple instances of training data from one training sequence by taking the first token as the input token sequence and the second token as the next token to create one instance, taking the first and second tokens as the input token sequence and the third token as the next token to create another instance, and so on.

In one or more embodiments, the contextual embedding for a sequence is determined by applying the pre-trained generator model 310 to the sequence of input tokens to generate a sequence of embeddings. The sequence of embeddings is combined to generate the contextual embedding. In the example shown in FIG. 3B, the training sequence includes a sequence of input tokens representing [pasta]>[Alfredo sauce]>[Olive oil]. The training module 230 applies the pre-trained generator model 310 to the sequence of input tokens and generates a set of embeddings E_pasta, E_Alfredo sauce, E_Olive oil. The embeddings are combined to generate a contextual embedding for the sequence.

The training module 230 applies the parameters of the classification layer 330 to the contextual embedding to generate a set of estimated predictions. In one or more embodiments, the set of estimated predictions are represented as a vector with a number of elements corresponding to the number of items in the vocabulary, where each element corresponds to a respective item in the vocabulary. Each element is associated with a likelihood that the item for the element comes after the sequence of input tokens. The next token for the training instance is encoded as a one-hot vector where the element for the known item is a one and the remaining elements are zero. In the example shown in FIG. 3B, the third element of the vector representing the next token is a one and other elements are zero as the third element represents the [chili pepper] item.

The training module 230 computes a loss function between the next token vector and the estimated prediction vector that indicates a difference between the two vectors. The training module 230 updates the parameters of the classification layer 330 to reduce the loss function. This process is repeated until a convergence criterion is reached. In this manner, given a sequence of input tokens, the classification layer 330 is incrementally trained to predict the item a user is likely to interact with next. In one or more embodiments, the parameters of the generator model 310 are frozen (unchanged), while the parameters of the classification layer 330 are updated.

In one or more embodiments, the training module 230 trains a recommendation model configured as an autoregressive model (e.g., XLNet). Specifically, the autoregressive model is coupled to receive a sequence of input tokens and generate an embedding representing a next token. In one or more embodiments, the training module 230 also performs a pre-training process to train parameters of the autoregressive model to learn the embedding space, and a training process to learn parameters of the classification layer.

During the pre-training process, the training module 230 obtains a training sequence and generates different permutations of the tokens in the sequence. For each token in the set of permuted sequences, the training module 230 applies parameters of the autoregressive model to the sequence of input tokens that come before the token to generate an estimated embedding and maps the embedding to an output token. The training module 230 obtains a loss function indicating a difference between the known token and the estimated output token. The training module 230 updates parameters of the autoregressive model to reduce a loss function. This way, the context for each position can incorporate information from all positions, capturing bidirectional context.

During the training process, the training module 230 trains parameters of a classification layer, similar to that described for classification layer 330 in FIG. 3B. In one or more embodiments, the training module 230 applies the autoregressive model to a set of input tokens from a training sequence to generate an embedding. The embedding is input to the classification layer to generate a set of estimated predictions for the set of items. The training module 230 computes a loss function indicating the difference between the estimated predictions and the label known for the next token. The training module 230 obtains one or more error terms from the loss function and updates parameters of the classification layer to reduce the loss function.

In one or more embodiments, the training module 230 may update the token space regularly (e.g., every D number of days, weekly, monthly) by obtaining the latest performance metric data on the items in the catalog. The training module 230 may train a new recommendation model based on the new token space. Specifically, the list of items that are popular may change over time depending on seasonality, month of the year, and the like. In this manner, the training module 230 can update the token space to reflect the popular items as well as an updated recommendation model that reflects this change of user demand in items of the online system 140.

Returning to FIG. 2, the recommendation module 235 receives indication that a user has started a browsing session on an interface of the online system 140 and generates one or more recommendations using the trained recommendation model. Specifically, the recommendation module 235 obtains from a feature store 245, a history of user actions for the user. The recommendation module 235 may perform one or more parsing operations, such as filtering the features to user actions for the current browsing session. The recommendation module 235 tokenizes the user actions to a sequence of token ID's.

FIG. 4 illustrates an example inference process using the generator and the classification layer, in accordance with one or more embodiments. The recommendation module 235 applies the trained recommendation model to the sequence of token IDs for the user. The output of the recommendation model may be a likelihood per item in the token space, as described in conjunction with FIGS. 3A-3B. The likelihood for an item may indicate a likelihood the user will add the item to the user's cart given the context of the user's browsing session so far.

For example, FIG. 4 illustrates a generator model 410 trained by the pre-training process of FIG. 3A and a classification layer 430 trained by the training process of FIG. 3B. Given a sequence of actions for a new session of a user, the recommendation module 235 converts the actions into a set of input tokens [cereal]>[milk]>[granola]. The recommendation module 235 applies the generator model 410 to generate a set of embeddings E_cereal, E_milk, E_granola. The embeddings are used to generate a contextual embedding. The recommendation module 235 applies the classification layer 430 to the contextual embedding and generates a set of predictions for the items in the vocabulary. As shown in FIG. 4, the items associated with the first and second elements have high likelihoods.

When the recommendation model is configured as an autoregressive model, the recommendation module 235 applies the trained autoregressive model to the set of input tokens to generate an embedding. The recommendation module 235 applies the classification layer to the embedding to generate the set of predictions.

The recommendation module 235 may apply various types of filtering logic based on the generated outputs to, for example, filter out which items are out-of-stock, not relevant, or are associated with sponsorship (e.g., associated with advertisements for the item). The recommendation module 235 selects a subset of items that have, for example, the highest prediction likelihoods. The recommendation module 235 may apply one or more use cases to the selected subset of items.

One example of a use case is to use an ads database to obtain sponsorship data such as ads campaign information for the selected subset of items, bid prices, and budgets. This information may be used to hold an ad auction to determine items for which ads will be displayed to the user during the browsing session. For example, the selected subset of items may be further provided to a predictive clickthrough (CTR) model, re-ranked according to the predicted CTR's of the model, and the ad for which the respective item has the highest ranking may be displayed to the user. As another example, the ad bidding process may re-rank the selected subset of items, and the ad with the highest bid may be displayed to the user.

Another example of a user case is cart completion for the user. In particular, the recommendation module 235 may only consider actions that are cart add events and shuffle the sequence of tokens for the user so that different permutations of the sequence of tokens are generated for the user (the permutations may not be sorted by timestamp). The recommendation module 235 may apply the recommendation model to the permutations and generate the likelihoods to identify a subset of items the user may likely add to complete the user's order. The recommendation module 235 displays a list of items to the user that the user can add to the user's order. The recommendation module 235 may additionally filter out items or item categories that are already in the user's cart.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

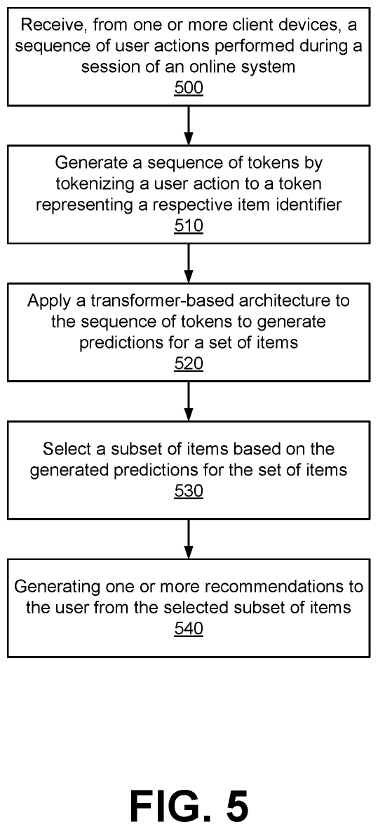

FIG. 5 is a flowchart for a method of generating recommendations using a transformer-based recommendation model, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The online system 140 receives 500, from one or more client devices, a sequence of actions performed by a user during a session of an application of an online system 140. The online system 140 generates 510 a sequence of tokens from the sequence of actions by tokenizing an action to a token representing a respective item identifier. The online system 140 applies 520 a transformer-based machine-learned model to the sequence of tokens to generate predictions for a set of items. A prediction for a respective item may indicate a likelihood the user will interact with a content item related to the item as a next action. The online system 140 selects 530 a subset of items based on the generated predictions for the set of items. The selected subset of items may have predictions above a predetermined threshold. The online system 140 generates 540 one or more recommendations to the user from the selected subset of items and displays the recommendations to the user.

### ADDITIONAL CONSIDERATIONS

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, from one or more client devices, a sequence of actions performed by a user during a session of an application of an online system;
generating a sequence of tokens from the sequence of actions by tokenizing an action to a token representing a respective item identifier;
applying a transformer-based machine-learned model to the sequence of tokens to generate predictions for a set of items, a prediction for a respective item indicating a likelihood the user will interact with a content item related to the item as a next action;
selecting a subset of items based on the generated predictions for the set of items, wherein the selected subset of items have predictions above a predetermined threshold;
generating one or more recommendations to the user from the selected subset of items; and
displaying the recommendations to the user.

2. The method of claim 1, wherein the user actions include one or more of viewing or clicking of a content item related to an item, adding an item to the cart of the user, or submitting a search query on an item on the application of the online system.

3. The method of claim 1, wherein the machine-learned model includes a generator model with a transformer-based machine-learned model and a classification layer, wherein the applying the transformer-based machine-learned model comprises:
applying the generator model to the sequence of tokens to generate a set of embeddings;
combining the set of embeddings to generate a contextual embedding; and
applying the classification layer to the contextual embedding to generate the predictions for the set of items.

4. The method of claim 3, further comprising performing a pre-training process for the generator model in conjunction with a discriminator model, comprising:
obtaining at least one training sequence describing another sequence of actions previously performed by another user tokenized to another sequence of tokens;
masking one or more positions of the training sequence;
applying parameters of the generator model to the masked training sequence to generate a set of estimated embeddings for the masked positions; and
for each masked position, generating a generator loss dependent on a likelihood the generator model predicted the token for the masked position.

5. The method of claim 4, further comprising:
generating a corrupt sequence by replacing tokens at the one or more masked positions with tokens sampled from the set of estimated embeddings from the generator model;
applying parameters of a discriminator model to the corrupt sequence to generate a prediction for each token indicating whether the token is a replaced token or an original token from the training sequence; and
for each token in the corrupt sequence:
if the token is an original token, generating a discriminator loss dependent on a likelihood the discriminator model predicted the token was an original token, or
if the token is a replaced token, generating a discriminator loss dependent on a likelihood the discriminator model predicted the token was a replaced token.

6. The method of claim 5, wherein the discriminator model is another transformer architecture model.

7. The method of claim 3, performing a training process for the classification layer, further comprising:
obtaining at least one training sequence describing another sequence of actions previously performed by another user tokenized to another sequence of tokens;
applying the generator model to a sequence of input tokens in the training sequence to generate a set of embeddings;
combining the set of embeddings to a contextual embedding;
applying parameters of the classification layer to the contextual embedding to generate estimated predictions for the set of items; and
generating a loss function indicating a difference between a vector indicating the predictions for the set of items and another vector representing a next token that comes after the sequence of input tokens in the training sequence; and
backpropagating one or more terms obtained from the loss function to update the parameters of the classification layer.

8. The method of claim 1, wherein generating the one or more recommendations comprises:
identifying a set of candidate content items promoting the selected subset of items;
entering the set of candidate content items into an auction and selecting one or more content items from the auction, wherein displaying the recommendations comprises displaying the one or more content items to the user; and
displaying the one or more content items to the user.

9. The method of claim 1, wherein displaying the recommendations comprises:
displaying one or more items from the selected subset of items to the user; and
receiving an indication the user added the one or more items to an order of the user.

10. The method of claim 1, further comprising:
filtering the selected subset of items for items with an associated sponsorship or items with availability at a retailer store to generate a filtered subset of items.

11. A non-transitory computer readable storage medium comprising stored program code instructions, the instructions when executed causes a processing system to:
receive, from one or more client devices, a sequence of actions performed by a user during a session of an application of an online system;
generate a sequence of tokens from the sequence of actions by tokenizing an action to a token representing a respective item identifier;
apply a transformer-based machine-learned model to the sequence of tokens to generate predictions for a set of items, a prediction for a respective item indicating a likelihood the user will interact with a content item related to the item as a next action;
select a subset of items based on the generated predictions for the set of items, wherein the selected subset of items have predictions above a predetermined threshold;
generate one or more recommendations to the user from the selected subset of items; and
provide the recommendations for display to the one or more client devices of the user.

12. The non-transitory computer readable storage medium of claim 11, wherein the user actions include one or more of viewing or clicking of a content item related to an item, adding an item to the cart of the user, or submitting a search query on an item on the application of the online system.

13. The non-transitory computer readable storage medium of claim 11, wherein the machine-learned model includes a generator model with a transformer-based machine-learned model and a classification layer, wherein the instructions when executed causes the processing system to:
apply the generator model to the sequence of tokens to generate a set of embeddings;
combine the set of embeddings to generate a contextual embedding; and
apply the classification layer to the contextual embedding to generate the predictions for the set of items.

14. The non-transitory computer readable storage medium of claim 13, the instructions when executed causes a processing system to:
obtain at least one training sequence describing another sequence of actions previously performed by another user tokenized to another sequence of tokens;
mask one or more positions of the training sequence;
apply parameters of the generator model to the masked training sequence to generate a set of estimated embeddings for the masked positions; and
for each masked position, generate a generator loss dependent on a likelihood the generator model predicted the token for the masked position.

15. The non-transitory computer readable storage medium of claim 14, the instructions when executed causes a processing system to:
generate a corrupt sequence by replacing tokens at the one or more masked positions with tokens sampled from the set of estimated embeddings from the generator model;
apply parameters of a discriminator model to the corrupt sequence to generate a prediction for each token indicating whether the token is a replaced token or an original token from the training sequence; and
for each token in the corrupt sequence:
if the token is an original token, generate a discriminator loss dependent on a likelihood the discriminator model predicted the token was an original token, or
if the token is a replaced token, generate a discriminator loss dependent on a likelihood the discriminator model predicted the token was a replaced token.

16. The non-transitory computer readable storage medium of claim 15, wherein the discriminator model is another transformer architecture model.

17. The non-transitory computer readable storage medium of claim 13, the instructions when executed causes a processing system to:
obtain at least one training sequence describing another sequence of actions previously performed by another user tokenized to another sequence of tokens;
apply the generator model to a sequence of input tokens in the training sequence to generate a set of embeddings;
combine the set of embeddings to a contextual embedding;
apply parameters of the classification layer to the contextual embedding to generate estimated predictions for the set of items; and
generate a loss function indicating a difference between a vector indicating the predictions for the set of items and another vector representing a next token that comes after the sequence of input tokens in the training sequence; and
backpropagate one or more terms obtained from the loss function to update the parameters of the classification layer.

18. The non-transitory computer readable storage medium of claim 11, the instructions when executed causes a processing system to, the instructions when executed causes the processing system to:
identify a set of candidate content items promoting the selected subset of items;
enter the set of candidate content items into an auction and selecting one or more content items from the auction, wherein instructions to display the recommendations further causes the processing system to display the one or more content items to the user; and
display the one or more content items to the user.

19. The non-transitory computer readable storage medium of claim 11, the instructions when executed causes a processing system to:
display one or more items from the selected subset of items to the user; and
receive an indication the user added the one or more items to an order of the user.

20. A computer system comprising:
a processor; and
a non-transitory computer-readable medium storing instructions that, when executed by the processor, cause the processor to:
receive, from one or more client devices, a sequence of actions performed by a user during a session of an application of an online system;
generate a sequence of tokens from the sequence of actions by tokenizing an action to a token representing a respective item identifier;
apply a transformer-based machine-learned model to the sequence of tokens to generate predictions for a set of items, a prediction for a respective item indicating a likelihood the user will interact with a content item related to the item as a next action;
select a subset of items based on the generated predictions for the set of items, wherein the selected subset of items have predictions above a predetermined threshold;
generate one or more recommendations to the user from the selected subset of items; and
provide the recommendations for display to the one or more client devices of the user.
